(19) United States
(12) Patent Application Publication
(10) Pub. No.: US 2025/0112033 A1
(43) Pub. Date: Apr. 3, 2025

(54) Methods for Analyzing Spectrometry Data

(71) Applicants: Guy Lawrence Cavet, Hillsborough, CA (US); Taran Driver, Stanford, CA (US)

(72) Inventors: Guy Lawrence Cavet, Hillsborough, CA (US); Taran Driver, Stanford, CA (US)

(21) Appl. No.: 18/479,114

(22) Filed: Oct. 2, 2023

(51) Int. Cl. H01J 49/00

(52) U.S. Cl. CPC H01J 49/0036

(57) ABSTRACT

The present invention features improved methods, computing devices, and computer-readable media to allow analysis of the composition of structures of matter. These innovations extract correlations between signals in spectral measurements and use these correlations to make inferences about the matter from which those measurements are derived.

### CROSS-REFERENCE TO RELATED APPLICATIONS

This non-provisional patent application claims the benefit of and priority to U.S. Provisional Patent Application No. 63/378,069, filed Oct. 2, 2022, which is hereby incorporated by reference in its entirety.

### BACKGROUND OF THE INVENTION

Spectrometry comes in many forms and often produces measurements of spectral intensity vs. a physical quantity such as mass-to-charge ratio, wavelength, kinetic energy, binding energy, etc. Standard data analysis techniques such as one-dimensional averaging over repeat measurements can hide useful signals, leaving a need for more advanced analysis methods to uncover richer information.

Mass spectrometry is a method for analyzing the composition of a structure of matter. For example, in tandem mass spectrometry (or, MS/MS) an ensemble of the molecule under analysis (e.g. a peptide ion) is caused to fragment (e.g. via collision-induced dissociation) and the mass-to-charge and relative abundance of the resultant fragments are recorded in a mass spectrum. From this mass spectrum, the original structure of the molecule under analysis can be inferred. This inference can take place through a number of different methods, e.g. using an existing experimental or theoretical database to search or compare known structures, or without the use of a database (e.g. de novo sequencing of protein, DNA or RNA molecules).

In mass spectrometric measurements, it can be possible to identify fragments born from the same decomposition pathway of the same parent molecule. The abundances of such fragments will be correlated across repeat measurements under appropriate experimental conditions. This relationship shall be referred to as ‘intrinsic correlation’. For example, for a peptide PEPTIDE²⁺ which dissociates via two separate pathways when caused to fragment: 1) PEPTIDE²⁺→PEP⁺+TIDE⁺ and 2) PEPTIDE²⁺→PEPTI⁺+DE⁺, it is possible to access direct experimental evidence for the two different pathways. In this example, there can be intrinsic correlation between the abundances of PEP⁺ and TIDE⁺, and between the abundances of PEPTI⁺ and DE⁺. This information can be useful for the purpose of reconstructing the parent molecule structure, understanding the decomposition process, and making other inferences.

One possible way to access intrinsic correlations is to calculate a covariance map across repeat scans in mass spectrometry. The discussion below pertains to two-dimensional covariance mapping, but covariance mapping extends to higher dimensions [Zhaunerchyk et al., Phys. Rev. A 89, 053318 (2014); Frasinski, J. Phys. B 49, 152004 (2016), Frasinski, arXiv:2204.03709 (2022)] and can be used to extract intrinsic correlations between more than two spectral signals. A simple covariance map between vectors X & Y is a two-dimensional matrix calculated across n samples where element i, j of the matrix holds the covariance between the i^{th} element of X and the i^{th} element of Y. The covariance between two variables x and y, cov(x, y), is:

$$cov ( x , y ) = 〈 ( x - 〈 x 〉 ) ( y - 〈 y 〉 ) 〉 = 〈 x y 〉 - ( x 〉 〈 y 〉 , \qquad ( 1 )$$

Where the angle brackets, e.g. [symbol] x [symbol] , represent an average over the plurality of spectra, e.g.:

$$〈 x 〉 = \frac{1}{{n}_{samples}} {\sum }_{i = 1}^{{𝔫}_{samples}} {x}_{i}$$

Natural fluctuations across repeat scans cause the spectral intensity of fragments that are intrinsically correlated to rise and fall in unison, i.e. have positive covariance. Areas of positive covariance in the map are referred to as “covariance islands”. Covariance islands due to intrinsic correlation will be referred to as islands of ‘intrinsic covariance’. Moreover, covariance has the useful property that the volume of the covariance island should be directly proportional to the concentration of the given parent molecule and its probability to dissociate via the given decomposition pathway. This can be useful for quantitative analysis.

However, in a standard mass spectrometry experiment, positive covariance islands can also result from factors other than intrinsic correlation. Fluctuating external parameters can also result in abundant positive covariance islands [Driver et al., Phys. Rev. X 10, 041004 (2020)] that are not due to intrinsic correlation. These islands are instead produced by ‘extrinsic correlation’, which refers to the synchronous rising and falling of spectral signals across scans due to fluctuations in an external and uninformative parameter. Extrinsic covariance, which takes the form of islands of positive covariance due to extrinsic correlation, can overwhelm the intrinsic covariance. This can reduce the useful information content of covariance maps.

In a proteomic MS/MS measurement, intrinsic covariance can appear between many different types of fragment ion. For example, intrinsic covariance often appears between two terminal fragment ions (e.g. a-, b-, c- and x-, y-, z-ions) following the cleavage of a single bond along the peptide backbone [Wysocki et al., Methods 35, 211 (2005)]. Intrinsic covariance can also appear between a terminal fragment ion and an internal fragment ion. An internal ion is a fragment ion that does not feature either the N- or C-peptide terminus, as a result of multiple bond cleavages. Intrinsic covariance islands between terminal and internal fragment ions can be highly ‘sequence-specific’ or ‘structurally specific’, meaning such signals have high specificity (low false positive rate) as indicators of the presence of a particular protein sequence and/or modification state.

One technique for distinguishing intrinsic covariance from extrinsic covariance is to calculate the partial covariance between each spectral bin and every other bin. This comprises subtracting a correction term from the simple covariance matrix that is an estimator of the contribution of extrinsic covariance to the full map. The equation for partial covariance to remove extrinsic covariance due to a single fluctuating parameter I (referred to as the control parameter) is:

$$p Cov ( x , y ; I ) = cov ( x , y ) - \frac{cov ( x , I ) cov ( I , y )}{cov ( I , I )} \qquad ( 2 )$$

can also be extended to multiple fluctuating control parameters using:

$$p Cov ( x , y ; I ) = cov ( x , y ) - c o v ( x , I ) \times {cov ( {I}^{T} , I )}^{- 1} cov ( I , y ) \qquad ( 3 )$$

where I is a row vector of different fluctuating parameters and cov(I^{T},I)⁻¹ is the inverse of the dispersion matrix of parameters I [Frasinski, J. Phys. B 49, 152004 (2016)]. Herein, the quantity calculated in Eq. 2 will be referred to as single parameter partial covariance and the quantity calculated in Eq. 3 will be referred to as multi-parameter partial covariance. The term ‘partial covariance’ will refer to both quantities.

The standard implementation of partial covariance requires the independent monitoring of all fluctuating parameters that produce extrinsic covariance. In many mass spectrometry measurements there are multiple fluctuating parameters that are highly challenging to measure on a shot-to-shot basis, making this a restrictively difficult requirement. However, it has been shown that it is possible to achieve suppression of extrinsic covariance in some circumstances by using the total ion count (TIC) as a proxy control parameter, and calculating the single parameter partial covariance using this value as a single control parameter [Driver et al., Phys. Rev. X 10, 041004 (2020)].

The use of single parameter partial covariance has been applied with success to mass spectrometry measurements of biopolymers. Mathematical analysis shows that the partial covariance using the total ion count as a single fluctuating parameter is able to reveal intrinsic covariance at the expense of extrinsic covariance under certain experimental conditions. However, there are several reasons for which an alternative form of identifying intrinsic covariance from extrinsic covariance may be desirable.

In the case of incomplete parent ion fragmentation, it is possible for the TIC single parameter partial covariance procedure to produce false positive intrinsic correlation islands (see term 3 of Eq. A1 in Driver et al., Phys. Rev. X 10, 041004 (2020)). Incomplete parent ion fragmentation is a common occurrence in tandem mass spectrometry measurements, especially for fragmentation mechanisms based on lasers (e.g. ultraviolet photodissociation or femtosecond laser-induced ionization/dissociation) or electron sources (e.g. electron capture dissociation/electron transfer dissociation).

Moreover, the TIC single parameter partial covariance procedure over-estimates the ‘correction term’ in Eq. 2 in situations where the fragmentation-to-detection efficiency is not sufficiently high, which can falsely suppress small intrinsic positive covariance islands on a TIC single parameter partial covariance map, resulting in loss of information. Suppression of intrinsic covariance can also happen when the branching ratio of all fragmentation pathways producing one or more of the spectral signals resulting in a positive covariance island is comparable to the branching ratio of all fragmentation pathways that do not produce one or more of the spectral signals resulting in a positive covariance island. In the case of large fragmenting biopolymers, this is rarely the case, but for MS/MS measurements on smaller molecules (e.g. for metabolomics) this is more likely to be the case and thus can present a problem. It is likely desirable to apply covariance mapping to metabolomic measurements, for example because the chromatographic separation of metabolites can be highly challenging.

The formulae for partial covariance (Eqs. 2 & 3) are derived under the strong assumption that the intensities of the spectral signals being correlated vary linearly with the value(s) of the partial covariance parameter(s). This is not the case for many physical processes of interest and utility, such as multiphoton ionization by a laser with fluctuating intensity. In such cases, partial covariance is unsuitable for suppressing extrinsic covariance.

Thus alternative approaches are needed to differentiate intrinsic and extrinsic covariance. While these approaches are broadly applicable in mass spectrometry, there are specific circumstances in which they may have particular utility.

### Isobaric Labeling for Quantitative Mass Spectrometry

In some embodiments, the present invention relates to the analysis of data generated using isobaric labeling for quantitative mass spectrometry, for example isobaric tags for relative and absolute quantification (iTRAQ) [P. L. Ross et al., Mol. Cell Proteomics 3, 1154 (2004)], and Tandem Mass Tags (TMTs) [A. Thompson, et al., Anal. Chem. 75, 1895 (2003); L. Dayon et al., Anal. Chem. 80, 2921 (2008)]. These techniques can be used to quantify different biomolecular species in a mass spectrometry measurement. For example biomolecules, e.g. peptides, can be tagged with TMTs prior to mass spectrometry (MS) analysis. These tagged biomolecules generate quantitative reporter ions (typically at low m/z values) under fragmentation in an MS/MS experiment. Quantitative reporter ions are ions whose measured abundance can be used to determine the quantities of the different tagged biomolecules in a complex biomolecular mixture.

In TMT measurements, co-isolation of contaminant biomolecules prior to the fragmentation step can present a problem. Co-isolated contaminant biomolecules carrying their own TMTs can produce their own reporter ions under fragmentation, which contaminates measurement of reporter ion abundance. This scenario has been dubbed ‘ratio distortion’, because the ratios of the abundances of the measured reporter ions are distorted by the contaminants [Ting et al., Nat. Meth. 8, 937 (2011)].

One solution to ratio distortion is to employ a second step of isolation/fragmentation on the ensemble of molecular fragments generated in the MS/MS measurement. Measurement schemes with this additional step of isolation/fragmentation are often known as ‘MS3’ experiments. By isolating sequence-specific fragment ions in an MS3 measurement, it is possible to match TMT reporter ions to their corresponding parent ions at the MS3 stage. By simultaneously isolating multiple MS2 fragments for MS3 measurement, it is possible to perform a multiplexed measurement that matches multiple TMTs to parent ions in a single stage of MS3 analysis. To enable such MS3 measurements to be performed efficiently, multiple TMTs are required on each precursor, meaning enzymatic digestion is typically performed with a selective enzyme such as Lys-C. MS3 measurements and multiplexed measurements requires specialized hardware to realize, and additional ions are lost at the MS3 step, reducing the overall efficiency of the measurement.

### De Novo Sequencing

In some embodiments, the present invention also pertains to the use of intrinsic covariance islands to perform de novo biomolecular sequencing. Here, de novo sequencing refers to the determination of biomolecular primary structure (for example, amino acid sequence, nucleic acid sequence, or modification state) where the structure is determined without the use of a sequence database. For example, this process may comprise determination of the sequence using known fragmentation rules, known masses of residues and modifications, and the positions of the intrinsic covariance islands.

### Data Independent Acquisition Workflows

In some aspects, the present invention also comprises the use of intrinsic covariance to implement new workflows for data independent acquisition (DIA) mass spectrometry. In DIA workflows, more than one type of parent ion is fragmented simultaneously and the fragment ions from multiple parent ions are used to determine the structures of the parent ions. The new workflows described here correspond to the intentional co-isolation of multiple precursor ions in a DIA workflow, and the use of intrinsic covariance to augment the data analysis. The intentional co-isolation could make use of direct infusion and/or the co-isolation of multiple parent ions, e.g. peptide ions or metabolomic ions, which can be challenging to separate chromatographically. The co-isolation of multiple parent ions could be performed using the same isolation voltages as used for e.g. MultiNotch MS3 measurements [G. C. McAlister et al., Anal. Chem. 86, 7150 (2014)].

### SUMMARY OF THE INVENTION

Disclosed herein are methods for determining intrinsic correlation and for using these metrics to analyze the structure of compositions.

In some aspects, intrinsic correlation is determined by measuring intrinsic covariance between two or more signals.

In some aspects, intrinsic covariance is identified by calculating the contingent covariance across a set of spectral measurements.

In some aspects, intrinsic covariance is identified by calculating the variation in calculated values of covariance across resampling of the scans that were used to calculate the map.

In some aspects, intrinsic covariance is identified using principal component analysis to isolate extrinsic covariance signals from intrinsic covariance signals.

In some aspects, intrinsic covariance is identified by calculating the multi-parameter partial covariance to remove the effect of fluctuations in multiple coupled or uncoupled control parameters.

In some aspects, one or more of the parameters for contingent covariance, one or more of the parameters for multi-parameter partial covariance, or one or more of the parameters whose effect is removed by principal component analysis, is the total integrated value of all or some of the spectral measurement, e.g. the total ion count (TIC) in a tandem mass spectrometry measurement

In some aspects, calculation of an aggregate measure of a region of a covariance map (including but not limited to simple covariance, partial covariance, contingent covariance, intrinsic covariance) is made more efficient by aggregating the value across multiple spectral bins in the 1D spectrum that cover a peak of interest before performing the covariance calculation.

In some aspects, intrinsic correlation between ions in a mass spectrometry measurement is used for de novo sequencing of a biomolecule.

In some aspects, intrinsic correlation is used to match reporter ions to sequence ions in measurements using quantitative isobaric labelling.

In some aspects, intrinsic correlation is used to improve measurements in data independent acquisition (DIA) mass spectrometry workflows.

Also described herein is a computing device, comprising one or more processors, memory, and instructions that cause the processors to analyze the structure of a composition of matter using intrinsic correlations.

Also described herein is a computer-readable medium storing processor-executable instructions, the processor-executable instructions including instructions that, when executed by one or more processors, cause the processors to analyze the structure of a composition of matter using intrinsic correlations.

### BRIEF DESCRIPTION OF THE SEVERAL VIEWS OF THE DRAWINGS

FIG. 1 shows a comparison between simple covariance (top), contingent covariance (middle), and TIC single parameter partial covariance (bottom) for the fragmentation under CID of the peptide ion [MLGIIAGKNSG+2H]²⁺.

FIG. 2 illustrates an application of intrinsic covariance in an experiment using isobaric labeling for quantitative mass spectrometry. In this example, the measurement uses tandem mass tags.

FIG. 3 illustrates the identification of intrinsic covariance through use of the volume of a simple covariance island divided by the standard deviation of this volume upon jackknife resampling

$$( \frac{Cov ( Y , X )}{σ ( Cov ( Y , X ) )} ) .$$

### DETAILED DESCRIPTION OF THE INVENTION

In one embodiment, the current invention comprises the identification of intrinsic covariance in MS/MS measurements for biomolecular structural analysis, without the use of partial covariance, by calculating the contingent covariance between one or many spectral bins and other spectral bins. The intrinsic covariance islands identified by the contingent covariance procedure are used for the structural analysis of molecular systems. The contingent covariance suppresses extrinsic covariance islands by calculating the simple covariance across subsets of scans grouped according to the value of a given scan parameter or parameters (e.g. total ion count), and aggregating the resulting simple covariance maps to produce a final map featuring intrinsic positive covariance but with extrinsic covariance suppressed. In the case where the control parameter varies linearly with the fragment intensity in each channel and with converged statistics, this approach gives the same result as perfect partial covariance would (i.e. the case where all fluctuating external parameters have been measured and accounted for using the multi-parameter partial covariance formula) [Zhaunerchyk et al., Phys. Rev. A 89, 053318 (2014); Frasinski, J. Phys. B 49, 152004 (2016)]. In the case where the control parameter(s) do not vary linearly with the fragment intensity in each channel, contingent covariance remains a mathematically valid approach to suppress extrinsic correlations. In contrast, partial covariance, which is derived on the assumption that the control parameter(s) vary(ies) linearly with the spectral intensities between which the partial covariance is being calculated, may not correctly suppress extrinsic covariance when there is a nonlinear relationship between the control parameter(s) and the spectral intensities. Contingent covariance on a parameter P is defined as [Zhaunerchyk et al., Phys. Rev. A 89, 053318 (2014)]:

$$c Cov ( x , y ; P ) = \frac{1}{K} {\sum }_{k = 1}^{K} cov ( x , y \vert P = {P}_{k} ) , \qquad ( 4 )$$

where x and y each represent spectrum intensity for a bin and P represents one or a set of control parameters used to divide the scans into K different sets for which P=Pₖ, where P=Pₖ indicates that P is equal to a value or set of values described by Pₖ or P falls within a range of values described by Pₖ and

$$cov ( x , y ) = 〈 ( x - 〈 x 〉 ) ( y - 〈 y 〉 ) 〉 = 〈 x y 〉 - 〈 x 〉 〈 y 〉 \qquad ( 1 )$$

where the angle brackets, e.g. [symbol] x [symbol] , represent an average over the plurality of spectra, e.g.:

$$〈 x 〉 = \frac{i}{{n}_{samples}} {\sum }_{i = 1}^{{n}_{samples}} {x}_{i}$$

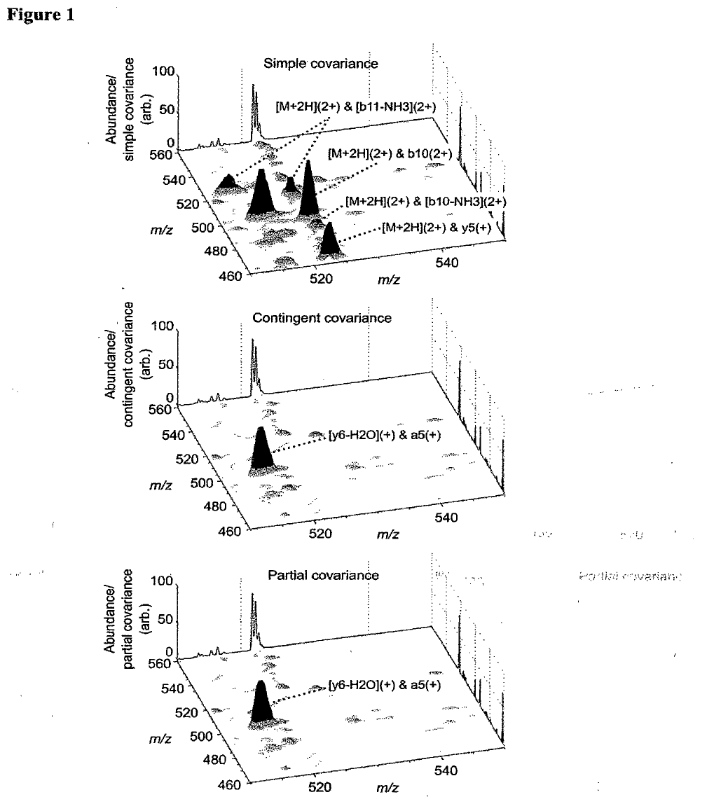

An unbiased estimator of the covariance for each set in which P=Pₖ requires multiplication by the factor

$$\frac{{n}_{k}}{{n}_{k} - 1} ,$$

where nₖ is the number of shots in the set [Zhaunerchyk et al., Phys. Rev. A 89, 053318 (2014)]. This correction factor, sometimes referred to as Bessel's correction, adjusts for the bias in the estimate of the covariance due to the difference between the sample mean and the population mean on account of the finite sample size in each set. The formula for contingent covariance does not assume any dimensionality and therefore can be extended to higher dimensions (x, y, z, etc.). A comparison of simple covariance, total ion count single parameter partial covariance, and contingent covariance (100 bins of 100 scans, contingent on value of the total ion count) is shown in FIG. 1. In this figure, the two-dimensional maps are built using 10,000 MS/MS scans of the doubly charged peptide in [MLGIIAGKNSG+2H]²⁺ under collision-induced activation (CID) with a normalized collision energy of 35%, activation time of 30 ms and Mathieu q-value of 0.25. The maps are plotted as a surface whose height encodes the value of the covariance. Plotted against the back walls of the maps is the 1D averaged spectrum acquired from a high-resolution, low scan rate measurement of the ion under the same experimental parameters as the scans used to calculate the map. The scans used to calculate the map were performed with lower resolution but higher scan rate, to minimize the required data acquisition time. The top panel shows the simple covariance map of a small region (m/z 510-550 & 460-560) calculated using Eq. 1. Annotated features are islands of covariance between the doubly charged parent ion [M+2H]²⁺ and the ion that is indicated. It is physically impossible for there to be intrinsic covariance between the doubly charged parent ion and any other fragment ion because the parent ion has not undergone fragmentation. The middle panel shows the two-dimensional contingent covariance map, calculated using Eq. 4. It is calculated with a single contingent variable P, which is the total ion count (TIC), using 100 bins of 100 shots each. In the contingent covariance map, the physically impossible correlation islands involving the doubly charged parent ion have been suppressed, revealing the only remaining positive covariance island to be between the fragment ions [y₅-H₂O]⁺& a₅⁺. These two signals are expected to produce intrinsic covariance according to the known sequence and known fragmentation rules. This is a clear indication that the contingent covariance succeeds in suppressing extrinsic covariance and identifying intrinsic covariance. The bottom panel shows the single parameter partial covariance map calculated using Eq. 2, where the single partial covariance parameter is the total ion count (TIC) of each MS/MS spectrum. Again, the physically impossible correlation islands involving the doubly charged parent ion have been suppressed, revealing the only remaining positive covariance island to be between the fragment ions [y₅-H₂O]⁺& a₅⁺. These two signals are expected to produce intrinsic covariance according to the known sequence and known fragmentation rules. This is a clear indication that the TIC single parameter partial covariance also succeeds in suppressing extrinsic covariance and identifying intrinsic covariance, as previously known.

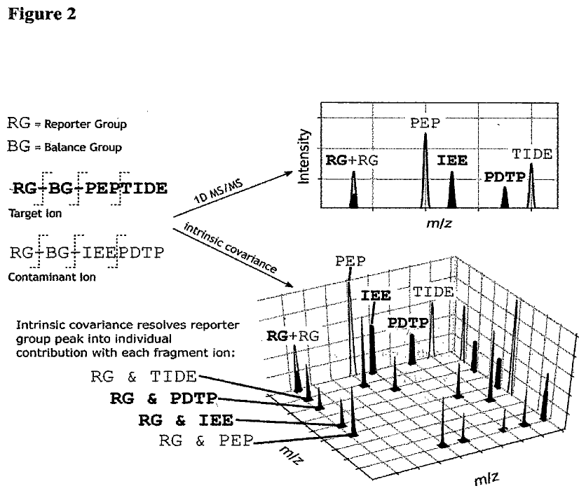

Isobaric Labeling for Quantitative Mass Spectrometry: Islands of intrinsic covariance appear between pairs of peaks that share common parent ion origin. In many circumstances, the value of the intrinsic covariance islands is linearly proportional to the abundance of parent ions and the branching ratio of the fragmentation process generating the signals that produce positive covariance. This opens the possibility to match quantitative reporter ions to specific fragment ions using intrinsic covariance. This can, for example, directly resolve the ratio distortion problem in TMT experiments. Sequence-specific fragment ions from a protein of interest can be matched with their corresponding TMTs directly at the first MS/MS level (the MS2 level). FIG. 2 shows an exemplary tandem mass tag (TMT) experiment in which the problem of ‘ratio distortion’ [Ting et al., Nat. Meth. 8, 937 (2011)] may be solved by the use of intrinsic covariance (which could be accessed via simple covariance, partial covariance, contingent covariance, intrinsic covariance). In this illustrative scheme, the target peptide ion with sequence PEPTIDE (boldface text, peaks filled in top panel) is co-isolated with isomeric contaminant sequence IEEPDTP (non-boldface text, peaks not filled in top panel) in an MS/MS measurement. Both peptides have been tagged with a TMT, consisting of a reporter group (RG), a balance group (BG) and a protein-reactive group (not drawn) which binds the TMT to the peptide. Under fragmentation of the full peptide+TMT molecular system, the balance group is lost as a neutral loss, the reporter group retains charge and is detected as a fragment ion, and the peptide backbone can also cleave to produce one or more sequence-specific fragment ions. The cleavages producing these molecular fragments are represented by dashed lines through the sequences shown in the figure. In conventional 1-dimensional (1D) MS, the presence of contaminant ions carrying their own TMTs can cause a distortion in the measured abundance of the target ion. This is illustrated in the top right panel, showing the 1D MS/MS experiment, where the measured intensity of the reporter group from the target ion is distorted by the presence of the reporter group from the contaminant ion. The signal intensity in the m/z channel associated with the reporter group for the target ion (leftmost peak) is artificially increased by the presence of the reporter group from the contaminant ion. This peak is labeled ‘RG+RG’, where RG (boldface) is the reporter group of the target ion and RG (not boldface) is the reporter group of the contaminant ion. Because the measured abundance of the target ion reporter group is used to quantify the target ion itself, this increase would result in an overestimation of the abundance of the target ion. However, by measuring the intrinsic covariance between the individual sequence ions and the reporter groups of the two parent ions (target and contaminant), it is possible to directly assign the TMT to sequence-specific fragment ions. This enables quantifying the abundance of reporter group ions produced by each of the two parent ions (target and contaminant). This is because the reporter groups produce intrinsic covariance with the sequence ions of the peptide ions to which the reporter groups are originally attached. The value of intrinsic covariance is linear in the abundance of the signals that correlate to produce it, enabling a quantitative measurement of the abundance of the reporter group on each of the different peptide ions of interest. This measurement scheme is naturally multiplexed: all fragment ion/reporter group covariance islands are available from the same scan.

De novo sequencing: The information available from intrinsic covariance between multiple fragment ions offers rich information for de novo sequencing. For example, on a two-dimensional covariance map, ions produced by the breaking of a single molecular bond in a biomolecule arrange themselves along so-called ‘mass conservation lines’: straight lines on the map representing ion pairs that have the same total mass and charge. Directly identifying these ions, which are typically highly structurally specific, can be very useful information for de novo sequencing algorithms. This allows the ions to be isolated from other less useful fragment ions, such as those resulting from multiple fragmentations of the same parent molecule. This information can be incorporated into a de novo sequencing algorithm designed for standard 1D MS/MS measurements, i.e. using an algorithm that tracks along a mass conservation line to identify the next residue in a sequence, or it can be used to pre-select fragment ions that are provided to a pre-existing de novo sequencing algorithm.

Data-independent acquisition workflows: Intrinsic covariance islands offer the possibility to straightforwardly deconvolve fragment ions originating from different parent ions by use of mass conservation lines. This can be used to map intrinsic covariance islands to parent ions of a given mass. Moreover, correlations involving internal ions are highly structurally specific and thus less likely than either 1D fragment signals or correlations between two terminal ions to produce a ‘false positive’ match with a putative signal from the wrong protein structure, in the process of inferring protein structure from a MS measurement. This means intrinsic covariance islands can be used in a DIA workflow to identify a peptide ion, in a search that includes a large number of different possible parent ions.

Use of principal component analysis to extract intrinsic covariance: the present invention also comprises the use of principal component analysis to isolate the intrinsic covariance between fragments in an MS/MS measurement. The eigenvectors of the diagonalized covariance (e.g. simple covariance, partial covariance, contingent covariance, etc.) matrix (i.e. the principal components) can represent either the combined fluctuation of all or many fragment ions with themselves (extrinsic covariance) and thus be removed, else they can represent fragments that are intrinsically correlated and so produce intrinsic covariance. In some cases where extrinsic covariance dominates the covariance map, the eigenvectors associated with extrinsic covariance will correspond to the largest eigenvalues.

Increasing efficiency of resampling calculations by integration of raw spectra: Covariance (including partial covariance and contingent covariance) has the property of linearity. By summing or otherwise aggregating the spectral intensity across regions of interest in a given spectrum before a covariance calculation, reducing the value to one or a few numbers, and calculating a measure of covariance between those numbers, it is possible to greatly speed up covariance calculations for the aggregate value (e.g. volume) of an island on a covariance map, e.g. for resampling calculations. This is in contrast to calculating a full multi-dimensional covariance map across multiple spectral bins of a spectral region of interest and integrating the values over the full resultant map.

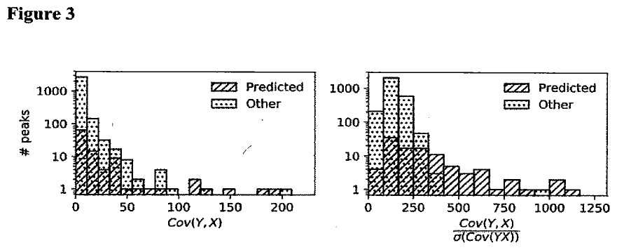

Resampling of covariance: Metrics such as the volume or height of an island on as covariance map are not necessarily a strong indicator of intrinsic covariance. However, it is possible to differentiate intrinsic covariance from extrinsic covariance by calculating the variation of a covariance island under resampling of scans. This approach can be applied to multiple methods for calculating covariance (including, but not limited to, simple covariance, partial covariance, and contingent covariance). In one embodiment, this consists of identifying extrinsic covariance on a simple covariance map by calculating the variation, e.g. standard deviation, of a some value (e.g. height, volume) of a covariance island across different resamples of the scans used to calculate the covariance map. The resampling could be performed according to a range of different resampling procedures, e.g. jackknife resampling or bootstrap resampling. Previous work [Driver et al., Phys. Rev. X 10, 041004 (2020)] has made use of jackknife resampling of features on a TIC single parameter partial covariance map, where extrinsic covariance has already been removed by the single parameter partial covariance procedure, to rank the strength of the observed intrinsic covariance islands and to distinguish low-intensity intrinsic covariance from statistical noise. In this prior work, resampling is used to identify the statistical significance of features on the single parameter partial covariance map. In contrast, the technique described here makes use of resampling of features on a simple covariance map to differentiate extrinsic covariance from intrinsic covariance. In this novel approach the resampling is not used to measure statistical significance (which is likely comparable between extrinsic and intrinsic covariance), but instead to identify intrinsic covariance. It has been found that covariance islands with a higher degree of variation across resamples are more likely to be extrinsic covariance instead of intrinsic covariance. In one embodiment, a metric to determine the likelihood that an island is intrinsic covariance could be calculated by dividing the height or volume of a covariance island by the standard deviation of the height or volume of said island upon resampling. Covariance islands with a higher value of this metric are more likely to represent intrinsic covariance. FIG. 3 illustrates the identification of intrinsic covariance by calculating the volume of a simple covariance island on a simple covariance map (calculated using Eq. 1) under jackknife resampling of the scans, for the intact protein ion myoglobin (13+) under collision-induced activation (CID) with a normalized collision energy of 70%, activation time of 30 ms and Mathieu q-value of 0.25. Predicted intrinsic covariance islands are first identified using the known charge state and sequence of the protein ion under analysis and known fragmentation rules. The left, panel shows histograms for covariance islands on the simple covariance map, binned by their volume. The right panel shows histograms for the same covariance islands, binned by their volume divided by the standard deviation of this volume upon jackknife resampling

$$\frac{Cov ( Y , X )}{σ ( Cov ( Y , X ) )} .$$

Predicted intrinsic covariance islands are shown with line hatch (labeled ‘Predicted’) and other covariance islands (likely extrinsic covariance islands) are shown with dot hatch (labeled ‘Other’). The intrinsic and extrinsic covariance islands are better distinguished using the volume of a simple covariance island divided by the standard deviation of that volume upon resampling

$$\frac{Cov ( Y , X )}{σ ( Cov ( Y , X ) )} .$$

This metric is a good indicator of intrinsic covariance (a high value indicates high likelihood of intrinsic covariance over extrinsic covariance), in contrast with the volume of the simple covariance island Cov(Y, X).

Partial covariance with multiple control parameters: In some instances, it may be desirable to identify intrinsic covariance by mathematically removing the effect of multiple control parameters, e.g. total ion count and laser pulse intensity. If all the multiple control parameters I, J, . . . are uncoupled (e.g. I and J are uncoupled if Cov(I,J)=0), the partial covariance can be calculated according to:

$$p Cov ( x , y ; I , J , … ) = cov ( x , y ) - \frac{cov ( x , I ) cov ( I , y )}{cov ( I , I )} - \frac{cov ( x , J ) cov ( J , y )}{cov ( J , J )} - ⋯ \qquad ( 5 )$$

However, if the covariance between any of the multiple control parameters is non-zero (or, the parameters are coupled), this needs to be accounted for in calculating the correction term which is subtracted from the simple covariance cov(x, y). In this case, the partial covariance to remove extrinsic covariance is calculated according to the formula:

$$p C o v ( x , y ; I ) = cov ( x , y ) - cov ( x , I ) \times cov {( {I}^{T} , I )}^{- 1} cov ( I , y ) \qquad ( 3 )$$

where I is a row vector of different control parameters and cov(I^{T},I)⁻¹ is the inverse of the dispersion matrix of the control parameters I. In the case where the covariance between all the control parameters is zero (all parameters are uncoupled), i.e. the case where Eq. 5 is a valid expression for the multi-parameter partial covariance, Eqs. 3 and 5 are equivalent.

Methods described herein can be used for electron spin resonance (ESR) spectra, nuclear magnetic resonance spectra, infrared spectra, Raman spectra, photoelectron spectra, UV/fluorescence spectra, and mass spectra. Mass spectra can appear as a measurement of relative abundance/spectral intensity versus mass-to-charge ratio, e.g. from a plurality of ions generated under decomposition analysis.

Control parameters could include an operating parameter or parameters of the apparatus generating the data sets and/or one or more measures of the experimental conditions under which the plurality of spectra was generated, for example chemical, electrical, mechanical, magnetic, thermal and/or optical conditions. Parameters could also include ion count or ion current for each spectrum; a total number of ions subjected to analysis for each spectrum; a total number of ions generated for each spectrum; a measure of intensity over one or more parts of the spectrum; a pressure of gas in an ion trap; a prescan ion count or current; a sample density in a mass analyzer, ion guide and/or collision cell; a rate of flow of ions into a mass analyzer; an intensity and/or pulse duration and/or wavelength of ionizing radiation, electrospray ionization capillary voltage; ion trap q-value; rf and de voltages applied to an ion trap; a time for which a voltage is applied to one or more of a tube lens, gate-lens, focusing lens, ion tunnel or multipole ion guide of the mass spectrometer, a voltage applied to one or more of a tube lens, gate lens, focusing lens, ion tunnel or multipole ion guide of the mass spectrometer. Parameters could also comprise a measure of the spectral intensity of at least a portion of each of the spectra, or a parameter derived from integration or summation of at least a portion of each spectrum. This portion of the spectrum could be determined as being at or about a mass-to-charge ratio corresponding to a parent ion or neutral or charged loss thereof or a fragment ion or neutral or charged loss thereof.

The parent ion could be a peptide, protein, lipid, animal or human metabolite, nucleic acid or other biomolecular ion. It could also be a petroleomic ion or other ion relevant for the chemical analysis of e.g. food and drug quality or environmental health. The ions (e.g. peptide or protein ions) could have been exposed to one or more enzymes prior to analysis, and possibly chromatographically separated prior to analysis.

The spectrum could relate to the intensity or abundance of a measure of mass-to-charge ratio (e.g. in a tandem mass spectrometry experiment), absorption or emission frequency of light, kinetic energy or time of flight of analyte particles, mass of analyte particles. The spectrum could be generated by dissociating one or more parent ions using e.g. collision-induced dissociation (CID), higher energy collisional dissociation/C-trap dissociation (HCD), electron transfer dissociation (ETD), electron capture dissociation (ECD), electron detachment dissociation (EDD), laser induced dissociation, surface induced dissociation (SID) or photodissociation.

A computing device is configured to carry out one or more of the above-described methods, functions or operations. The computing device includes one or more processors, each of which may include one or more microprocessors, application specific integrated circuits (ASICs), microcontrollers, or similar computer processing devices. The computing device may further include memory, which may include persistent and non-persistent memory, to store values, variables, and in some instances processor-executable program instructions. The computing device may include a network interface. The computing device may include a processor-executable application containing processor-executable instructions that, when executed, cause the processor to carry out one or more of the methods, functions or operations described herein.

1. A method of analyzing a structure of a composition of matter in a sample, comprising:
obtaining a data set comprising a plurality of spectra from the composition;
determining intrinsic correlations between two or more signals in the spectrum; and
using the intrinsic correlations to identify fragments derived from the same decomposition pathway of the same parent molecule or ion in order to make inferences about the structure of the composition of matter.

2. The method of claim 1 wherein the intrinsic correlation is determined by determining the intrinsic covariance between two or more signals in a spectrum.

3. The method of claim 2 wherein the intrinsic covariance is determined by obtaining a data set comprising a plurality of spectra from the composition;
dividing each of the spectra into a plurality of bins;
determining a control parameter or parameters indicative of synchronized fluctuations in signal intensity across some or all bins that result in universal correlation between said bins; and
calculating a contingent covariance of different bins across the plurality of spectra, and using the control parameter or parameters to suppress the correlation of intensity fluctuations between said bins.

4. The method of claim 3 wherein said calculating of the contingent covariance cCov(x, y; P) is performed according to the equation:
$$c Cov ( x , y ; P ) = \frac{1}{K} {\sum }_{k = 1}^{K} cov ( x , y \vert P = {P}_{k} ) ,$$
where x and y each represent spectrum intensity for a bin and P represents one or a set of control parameters used to divide the scans into K different sets for which P=Pₖ, where P=Pₖ indicates that P is equal to a value or set of values described by Pₖ or P falls within a range of values described by Pₖ, and
$$cov ( x , y ) = 〈 ( x - 〈 x 〉 ) ( y - 〈 y 〉 ) 〉 = 〈 x y 〉 - 〈 x 〉 〈 y 〉 ,$$
where the angle brackets, e.g. [symbol] x [symbol] , represent an average over the plurality of spectra.

5. The method of claim 3 wherein said calculating of the contingent covariance cCov(x, y, z; P) is performed according to the equation:
$$c Cov ( x , y , z ; P ) = \frac{1}{K} {\sum }_{k = 1}^{K} cov ( x , y , z \vert P = {P}_{k} ) ,$$
where x, y and z each represent spectrum intensity for a bin and P represents one or a set of control parameters used to divide the scans into K different sets for which P=Pₖ, where P=Pₖ indicates that P is equal to a value or set of values described by Pₖ or P falls within a range of values described by Pₖ, and
$$cov ( x , y , z ) = 〈 ( x - 〈 x 〉 ) ( y - 〈 y 〉 ) ( z - 〈 z 〉 ) 〉$$
where the angle brackets, e.g. [symbol] x [symbol] , represent an average over the plurality of spectra.

6. The method of claim 3 wherein said calculating of the contingent covariance cCov(x, y, z, . . . ; P) is performed according to the equation:
$$c Cov ( x , y , z , … ; P ) = \frac{1}{K} {\sum }_{k = 1}^{K} cov ( x , y , z , … \vert P = {P}_{k} ) ,$$
where x, y, z, etc. each represent spectrum intensity for a bin and P represents one or a set of control parameters used to divide the scans into K different sets for which P=Pₖ, where P=Pₖ indicates that P is equal to a value or set of values described by Pₖ or P falls within a range of values described by Pₖ, and cov(x, y, z, . . . ) represents the covariance of the spectrum intensity between four or more bins x, y, z, . . . .

7. The method of claim 2 wherein the intrinsic covariance is determined by obtaining a data set comprising a plurality of spectra from the composition;
dividing each of the spectra into a plurality of bins;
calculating a covariance of different bins across the plurality of spectra; and
determining intrinsic correlations between two or more signals in the spectrum by use of principal component analysis to isolate intrinsic covariance from extrinsic covariance caused by synchronized fluctuations in signal intensity across some or all bins due to fluctuating experimental parameters.

8. The method of claim 3 wherein the control parameters comprise one or more of:
an operating parameter or parameters of an apparatus generating the data sets and/or one or more measures of the experimental conditions under which the plurality of spectra was generated, for example chemical, electrical, mechanical, magnetic, thermal and/or optical conditions;
total or partial ion count or ion current for each spectrum;
a total number of ions subjected to analysis for each spectrum;
a total number of ions generated for each spectrum;
a measure of intensity over one or more parts of the spectrum;
a pressure of gas in an ion trap;
a prescan ion count or current;
a sample density in a mass analyzer; ion guide and/or collision cell;
a rate of flow of ions into a mass analyzer;
a total yield and/or intensity and/or pulse duration and/or wavelength of ionizing radiation;
a total yield and/or intensity and/or pulse duration and/or kinetic energy of incident electrons or ions;
electrospray ionization capillary voltage;
ion trap q-value;
rf and dc voltages applied to an ion trap;
a time for which a voltage is applied to one or more of a tube lens, gate lens, focusing lens, ion tunnel or multipole ion guide of the mass spectrometer;
a voltage applied to one or more of a tube lens, gate lens, focusing lens, ion tunnel or multipole ion guide of the mass spectrometer;
a measure of the spectral intensity of at least a selected portion of each of the spectra;
a parameter derived from integration or summation of at least a portion of each spectrum; and
elapsed time.

9. The method of claim 7 wherein the fluctuating external parameters comprise one or more of:
an operating parameter or parameters of an apparatus generating the data sets and/or one or more measures of the experimental conditions under which the plurality of spectra was generated, for example chemical, electrical, mechanical, magnetic, thermal and/or optical conditions;
total or partial ion count or ion current for each spectrum;
a total number of ions subjected to analysis for each spectrum;
a total number of ions generated for each spectrum;
a measure of intensity over one or more parts of the spectrum;
a pressure of gas in an ion trap;
a prescan ion count or current;
a sample density in a mass analyzer; ion guide and/or collision cell;
a rate of flow of ions into a mass analyzer;
a total yield and/or intensity and/or pulse duration and/or wavelength of ionizing radiation;
a total yield and/or intensity and/or pulse duration and/or kinetic energy of incident electrons or ions;
electrospray ionization capillary voltage;
ion trap q-value;
rf and de voltages applied to an ion trap;
a time for which a voltage is applied to one or more of a tube lens, gate lens, focusing lens, ion tunnel or multipole ion guide of the mass spectrometer;
a voltage applied to one or more of a tube lens, gate lens, focusing lens, ion tunnel or multipole ion guide of the mass spectrometer;
a measure of the spectral intensity of at least a selected portion of each of the spectra; and
a parameter derived from integration or summation of at least a portion of each spectrum.

10. The method of claim 2 wherein the intrinsic covariance is determined by obtaining a data set comprising a plurality of spectra from the composition;
dividing each of the spectra into a plurality of bins;
calculating a covariance of different bins across the plurality of spectra;
calculating the variance of the covariance upon resampling of the contributing spectra; and
determining intrinsic correlations between two or more signals in the spectrum by selecting the correlations for which the value of this variance is lower.

11. The method of claim 2 wherein the intrinsic covariance is determined by obtaining a data set comprising a plurality of spectra from the composition;
dividing each of the spectra into a plurality of bins;
calculating a simple covariance of different bins across the plurality of spectra;
calculating the standard deviation of the simple covariance upon resampling of the contributing spectra;
normalizing the value of the simple covariance by this standard deviation; and determining intrinsic correlations between two or more signals in the spectrum by selecting the correlations for which this normalized value is higher.

12. The method of claim 1 wherein the structural property comprises the quantity of one or more constituent substances in the composition, which is determined by using intrinsic correlation to match quantitative reporter ions to sequence-specific ions in a quantitative mass spectrometry measurement.

13. The method of claim 1 wherein the structural property comprises the biomolecular sequence, and the intrinsic correlation is used to perform de novo sequencing of a biopolymer using only knowledge of fragmentation rules, masses of constituent residues, and masses of modifications, and without the use of a biopolymer database.

14. The method of claim 1 wherein the intrinsic correlations are used for the implementation of a data-independent workflow, whereby multiple parent ions are intentionally co-isolated and co-fragmented and the intrinsic correlation between two or more signals is used to augment the data analysis.

15. The method of claim 2 wherein the intrinsic covariance is determined by calculating the partial covariance using multiple control parameters, according to the equation:
$$p Cov ( x , y ; I ) = cov ( x , y ) - cov ( x , I ) \times cov {( {I}^{T} , I )}^{- 1} cov ( I , y )$$
where I is a row vector of different control parameters and cov(I^{T},I)⁻¹ is the inverse of the dispersion matrix of control parameters I.

16. The method of claim 15 wherein the control parameters comprise two or more of:
an operating parameter or parameters of an apparatus generating the data sets and/or one or more measures of the experimental conditions under which the plurality of spectra was generated, for example chemical, electrical, mechanical, magnetic, thermal and/or optical conditions;
total or partial ion count or ion current for each spectrum;
a total number of ions subjected to analysis for each spectrum;
a total number of ions generated for each spectrum;
a measure of intensity over one or more parts of the spectrum;
a pressure of gas in an ion trap;
a prescan ion count or current;
a sample density in a mass analyzer; ion guide and/or collision cell;
a rate of flow of ions into a mass analyzer;
a total yield and/or intensity and/or pulse duration and/or wavelength of ionizing radiation;
a total yield and/or intensity and/or pulse duration and/or kinetic energy of incident electrons or ions;
electrospray ionization capillary voltage;
ion trap q-value;
rf and dc voltages applied to an ion trap;
a time for which a voltage is applied to one or more of a tube lens, gate lens, focusing lens, ion tunnel or multipole ion guide of the mass spectrometer;
a voltage applied to one or more of a tube lens, gate lens, focusing lens, ion tunnel or multipole ion guide of the mass spectrometer;
a measure of the spectral intensity of at least a selected portion of each of the spectra; and
a parameter derived from integration or summation of at least a portion of each spectrum.

17. The method of claim 2 wherein calculating the aggregate value of a covariance island comprises aggregating across relevant spectral bins prior to the covariance calculation, thereby reducing the number of numerical operations required to calculate an aggregated value of a covariance island by exploiting the linearity of covariance operations.

18. A computing device comprising:
one or more processors;
memory; and
computer-executable instructions stored in the memory that, when executed by the one or more processors, cause the processors to carry out the method claimed in claim 1.

19. A computer-readable medium storing processor-executable instructions, the processor-executable instructions including instructions that, when executed by one or more processors, cause the processors to carry out the method claimed in claim 1.
